(19) United States
(12) Patent Application Publication
(10) Pub. No.: US 2022/0305308 A1
(43) Pub. Date: Sep. 29, 2022

(54) Two-Part Locking Polymer Hub for Cable Self-Retracting Device

(71) Applicant: MSA Technology, LLC, Cranberry Township, PA (US)

(72) Inventors: Bryan Kroh, Harmony, PA (US); Matthew Frederick Jacob, Pittsburgh, PA (US); Michael Goodspeed, Pittsburgh, PA (US); Daniel Amankwah, Cranberry Township, PA (US)

(21) Appl. No.: 17/213,520

(22) Filed: Mar. 26, 2021

(51) Int. Cl. A62B 35/00

(52) U.S. Cl. CPC A62B 35/0093

(57) ABSTRACT

Provided is a self-retracting device including a rotatable hub assembly. The rotatable hub assembly includes a first half and a second half. The first half includes a slot for an axle. The second half includes a retraction member and a slot for the axle. The self-retracting device also includes an axle with a body extending through the slot of the first half and the slot of the second half and a line. A first end of the line includes a loop, wherein the loop is between the first half and the second half and the axle body extends through an opening defined by the loop. The rotatable hub assembly is configured to retract the line when the rotatable hub assembly moves in the first rotational direction and pay out the line when the rotatable hub assembly moves in a second rotational direction opposite the first rotational direction.

### TECHNICAL BACKGROUND

### Technical Field

The present disclosure relates generally to safety systems and arrangements and, in particular, to a line retraction device, such as a fall arrest or controlled descent device, including self-retracting lanyards and the like, which may be used in connection with a harness to protect the wearer from a sudden, accelerated fall arrest event, as well as a line retraction device having cable termination arranged around a central axis.

### Technical Considerations

As is known in the art, various fall arrest systems exist to provide assistance to a wearer or ensure the wearer's safety in certain situations. Such fall arrest systems come in many forms, including, but not limited to, line retraction devices used in connection with a harness and an energy absorber. In some embodiments or aspects, one end of a line retraction device is connected to an anchor point and an opposing end is connected to an energy absorber, which is in turn connected to the harness. In other embodiments or aspects, the opposing end of the line retraction device is connected directly to the harness, with the energy absorber device being integrated with the line retraction device or the harness.

In some examples, a line retraction device may be in the form of a lanyard, such as a self-retracting lanyard (SRL). SRLs have numerous industrial end uses, including, but not limited to, construction, manufacturing, hazardous materials/remediation, asbestos abatement, spray painting, sand blasting, welding, mining, numerous oil and gas industry applications, electric and utility, nuclear energy, paper and pulp, sanding, grinding, stage rigging, roofing, scaffolding, telecommunications, automotive repair and assembly, warehousing, and railroading.

In some applications, an SRL is attached at one end to an anchor point and at its other end to an energy absorber that is connected or directly integrated with a harness worn by the user. The SRL has a housing with a rotatable drum having a safety line wound about the drum and a braking mechanism for controlling the rotation of the drum and the resulting unwinding or winding of the safety line from/into the drum. The drum can rotate in a direction to unwind (or “pay out”) the safety line from the housing when a certain level of tension is deliberately applied. When tension is reduced or released, the drum can slowly rotate in a reverse direction, thereby causing the safety line to retract or rewind onto the drum. In this manner, the user can move around the work site without having the safety line dragging behind and impairing the user's movement.

The braking mechanism of the SRL is configured for slowing down and stopping the rotation of the drum when the safety line unwinds too rapidly. For example, the braking mechanism may be activated to brake (i.e., slow down and eventually stop) the rotation of the drum when the rotation speed exceeds a predetermined maximum speed for normal unwinding. A sudden unwinding of the safety line at a speed that exceeds normal pay out is an indication that the user has experienced a fall that needs to be stopped or arrested. Should such an unintentional, accidental fall commence, the braking mechanism in the housing of the SRL is configured to engage and stop further unwinding of the safety line, thereby stopping the user from falling any farther.

In addition to the fall arresting action provided by the SRL, the energy absorber is configured to activate when the force on the safety line between the SRL and the harness exceeds a predetermined threshold to arrest the fall slowly enough to prevent injury to the user. The stopping force provided by the SRL brake and the energy absorber is inversely proportional to the stopping distance, (i.e., the higher the force, the shorter the distance, and vice versa). As a result, the force cannot exceed a predetermined maximum (set by an industry standard), and yet it must also be large enough so that the stopping distance does not exceed a predetermined maximum (also set by an industry standard).

The drum generally needs to support substantial dynamic and static loads in the event of a fall and when the entire cable is released. Load requirements for SRLs are found in a variety of ANSI, OSHA, and CSA standards. SRLs typically utilize a drum made of aluminum to support the required loads. The line is terminated on the aluminum hub itself to prevent the cable from breaking loose and separating from the hub. The use of aluminum for the hub results in a heavy SRL and costly manufacturing and material costs.

Accordingly, there is a need in the art for an improved fall arrest system that addresses certain drawbacks and deficiencies associated with existing fall arrest systems. For example, there is a need for an improved fall arrest system to be made of a cheaper material that still meets the load requirements in the event of a fall.

### SUMMARY OF THE DISCLOSURE

Accordingly and generally, provided is a line retraction device having an improved cable termination arrangement. In particular, provided is an improved line retraction device having cable termination around a central axis.

In one preferred and non-limiting embodiment or aspect, provided is a self-retracting device. The self-retracting device may include a rotatable hub assembly comprising a first half and a second half. The first half may include a retraction member and a first slot for an axle. The second half may include a second slot for the axle. The first half may be connectable to the second half and the retraction member may bias the rotatable hub assembly in a first rotational direction. The self-retracting device may also include an axle with a body extending through the first slot of the first half and the second slot of the second half and a line. A first end of the line may include a loop positioned between the first half and the second half of the rotatable hub assembly and then extending around the body of the axle. A second end of the line opposite the first end may be configured for extending around a perimeter of the rotatable hub assembly. The rotatable hub assembly may be configured to retract the line when the rotatable hub moves in the first rotational direction and pay out the line when the rotatable hub moves in a second rotational direction opposite the first rotational direction.

In some non-limiting embodiments or aspects, the loop may be formed with a ferrule termination. The first half and the second half may be made of a plastic material. The first half may be connected to the second half with one or more snap locking tabs. The one or more snap locking tabs may prevent the first half and the second half from rotating backwards and disassembling. The first half is connected to the second half through a rotational motion, wherein the first half or the second half comprises a line tab for bending the line around the perimeter during the rotational motion. The line tab may cause the line to bend tangentially with the perimeter of the rotatable hub assembly. The line may bend around the perimeter in a same plane as the loop. The second half may include a braking mechanism configured to prevent rotation of the rotatable hub assembly upon activation of the braking mechanism when a rotational velocity of the rotatable hub assembly exceeds a predetermined threshold. The braking mechanism may include a first portion and a second portion, wherein the first portion engages with the second portion when the predetermined threshold is exceeded.

In one preferred and non-limiting embodiment or aspect, provided is a method of assembling a self-retracting device. The method of assembling the self-retracting device may comprise placing a loop of a first end of a line on a first half of a rotatable hub assembly and placing a second half of the rotatable hub assembly on the first half of the rotatable hub assembly such that the loop is between the first half and the second half. The method of assembling the self-retracting device may further comprise inserting an axle through an assembly slot extending through the first half and the second half of the rotatable hub assembly such that the loop of the line extends around a body of the axle and wrapping a body of the line around a perimeter of the rotatable hub assembly.

In some non-limiting embodiments or aspects, the loop may be formed with a ferrule termination. The first half and the second half may be made of a plastic material. The first half may be connected to the second half with one or more snap locking tabs. The one or more snap locking tabs may prevent the first half and the second half from rotating backwards and disassembling. The first half is connected to the second half through a rotational motion, wherein the first half or the second half comprises a line tab for bending the line around the perimeter during the rotational motion. The line tab may cause the line to bend tangentially with the perimeter of the rotatable hub assembly. The line may bend around the perimeter in the same plane as the loop. The second half may include a braking mechanism configured to prevent rotation of the rotatable hub assembly upon activation of the braking mechanism when a rotational velocity of the rotatable hub assembly exceeds a predetermined threshold. The braking mechanism may include a first portion and a second portion, wherein the first portion engages with the second portion when the predetermined threshold is exceeded.

Further preferred and non-limiting embodiments or aspects will now be described in the following numbered clauses.

Clause 1: A self-retracting device comprising: a rotatable hub assembly comprising a first half and a second half, wherein: the first half comprises a retraction member and a first slot for an axle; the second half comprises a second slot for the axle; the first half is connectable to the second half; and the retraction member biases the rotatable hub assembly in a first rotational direction; the axle comprising a body extending through the first slot of the first half and the second slot of the second half; and a line, wherein: a first end of the line comprises a loop positioned between the first half and the second half of the rotatable hub assembly and then extending around the body of the axle; and a second end of the line opposite the first end configured for extending around a perimeter of the rotatable hub assembly, wherein the rotatable hub assembly is configured to retract the line when the rotatable hub moves in the first rotational direction; and pay out the line when the rotatable hub assembly moves in a second rotational direction opposite the first rotational direction.

Clause 2: The self-retracting device of clause 1, wherein the loop is formed with a ferrule termination.

Clause 3: The self-retracting device of clause 1 or 2, wherein the first half and the second half are made of a plastic material.

Clause 4: The self-retracting device of any of clauses 1-3, wherein the first half is connected to the second half with one or more snap locking tabs.

Clause 5: The self-retracting device of any of clauses 1-4, wherein the one or more snap locking tabs prevents the first half and the second half from rotating backwards and disassembling.

Clause 6: The self-retracting device of any of clauses 1-5, wherein the first half is connected to the second half through a rotational motion, wherein the first half or the second half comprises a line tab for bending the line around the perimeter during the rotational motion.

Clause 7: The self-retracting device of any of clauses 1-6, wherein the line tab causes the line to bend tangentially with the perimeter of the rotatable hub assembly.

Clause 8: The self-retracting device of any of clauses 1-7, wherein the line bends around the perimeter in a same plane as the loop.

Clause 9: The self-retracting device according to any of clauses 1-8, wherein the second half comprises a braking mechanism configured to prevent rotation of the rotatable hub assembly upon activation of the braking mechanism when a rotational velocity of the rotatable hub assembly exceeds a predetermined threshold.

Clause 10: The self-retracting device according to any of clauses 1-9, wherein the braking mechanism comprises a first portion and a second portion, and wherein the first portion engages with the second portion when the predetermined threshold is exceeded.

Clause 11: A method of assembling a self-retracting device comprising: placing a loop of a first end of a line on a first half of a rotatable hub assembly; placing a second half of the rotatable hub assembly on the first half of the rotatable assembly such that the loop is between the first half and the second half; inserting an axle through an assembly slot extending through the first half and the second half of the rotatable hub assembly such that the loop of the line extends around a body of the axle; and wrapping a body of the line around a perimeter of the rotatable hub assembly.

Clause 12: The method of assembling the self-retracting device of clause 11, wherein the loop is formed with a ferrule termination.

Clause 13: The method of assembling the self-retracting device of clause 11 or 12, wherein the first half and the second half are made of a plastic material.

Clause 14: The method of assembling the self-retracting device of any of clauses 11-13, further comprising connecting the second half of the rotatable hub assembly to the first half of the rotatable hub assembly with one or more snap locking tabs.

Clause 15: The method of assembling the self-retracting device of any of clauses 11-14, wherein the one or more snap locking tabs prevents the first half and the second half from rotating backwards and disassembling.

Clause 16: The method of assembling the self-retracting device of any of clauses 11-15, further comprising connecting the second half of the rotatable hub assembly to the first half of the rotatable hub assembly by placing the second half on the first half and rotating the second half, wherein the first half or the second half comprises a line tab, wherein the line tab bends the body of the line around the perimeter during the rotation of the second half.

Clause 17: The method of assembling the self-retracting device of any of clauses 11-16, wherein the line tab bends the body of the line tangentially with the perimeter of the rotatable hub assembly.

Clause 18: The method of assembling the self-retracting device of any of clauses 11-17, wherein the line bends around the perimeter in the same plane as the loop.

Clause 19: The method of assembling the self-retracting device of any of clauses 11-18, wherein the second half comprises a braking mechanism configured to prevent rotation of the rotatable hub assembly upon activation of the braking mechanism when a rotational velocity of the rotatable hub assembly exceeds a predetermined threshold.

Clause 20: The method of assembling the self-retracting device of any of clauses 11-19, wherein the braking mechanism comprises a first portion and a second portion, wherein the first portion engages with the second portion when the predetermined threshold is exceeded.

These and other features and characteristics of the present invention, as well as the methods of operation and functions of the related elements and structures, and the combination of parts, and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a front perspective view of a fall protection device according to one aspect of the present disclosure.

FIG. 2 is an exploded, perspective view of the fall protection device of FIG. 1 according to one aspect of the present disclosure.

FIG. 3 is an isometric view of a rotatable hub assembly according to one aspect of the present disclosure.

FIG. 4 is a rear view of the rotatable hub assembly of FIG. 3 according to one aspect of the present disclosure

FIG. 5 is a front view of the rotatable hub assembly of FIG. 3 according to one aspect of the present disclosure

FIG. 6 is a side view of the rotatable hub assembly of FIG. 3 according to one aspect of the present disclosure.

FIG. 7 is an exploded, side view of the rotatable hub assembly of FIG. 3 according to one aspect of the present disclosure

FIG. 8 is a cross-sectional view along line VIII-VIII shown in FIG. 4 according to one aspect of the present disclosure.

FIG. 9 is a cross-sectional, isometric view along line IX-IX shown in FIG. 8 according to one aspect of the present disclosure with a line in place.

FIG. 10 is a rear view of the first half of the rotatable hub assembly of FIG. 3 according to one aspect of the present disclosure.

FIG. 11 is an isometric view of the first half of the rotatable hub assembly of FIG. 3 according to one aspect of the present disclosure.

FIG. 12 is a rear view of the second half of the rotatable hub assembly of FIG. 3 according to one aspect of the present disclosure.

FIG. 13 is an isometric view of the second half of the rotatable hub assembly of FIG. 3 according to one aspect of the present disclosure.

### DETAILED DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the embodiments or aspects as shown in the drawing figures and are not to be considered as limiting as the embodiments or aspects can assume various alternative orientations.

All numbers used in the specification and claims are to be understood as being modified in all instances by the term “about”. By “about” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The discussion of various examples or aspects may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the various examples and aspects described herein.

The disclosure comprises, consists of, or consists essentially of, the following examples or aspects, in any combination. Various examples or aspects of the disclosure are illustrated in separate drawing figures. However, it is to be understood that this is simply for ease of illustration and discussion. In the practice of the disclosure, one or more examples or aspects shown in one drawing figure can be combined with one or more examples or aspects shown in one or more of the other drawing figures.

This disclosure includes a rotatable hub assembly made of two parts with a cable eyelet terminating on the axle of the rotatable hub assembly. By using an eyelet of the cable around the axle instead of securing the cable to the hub itself, the rotatable hub assembly itself no longer needs to withstand the substantial forces that current rotatable hub assemblies are required to withstand. This allows the rotatable hub assembly to be made with cheaper materials, such as plastic. The rotatable hub assembly may be allowed to fail or break without risk to the user due to the cable still being secured by the axle. The use of a plastic material decreases the cost of materials for manufacturing of the rotatable hub assembly, and also decreases the cost of assembly. The rotatable hub assembly can be made of two separate parts that are connected together, allowing the cable to be secured during the assembly of the rotatable hub assembly. The two separate parts may be irreversibly connected with an irreversible locking mechanism to reduce the likelihood that the rotatable hub assembly would disassemble during use. Generally, bending the cable by hand may be difficult for smaller diameter rotatable drum assemblies. The rotatable hub assembly may include a mechanism for bending the cable during assembly to bend the cable tangential to the drum of the assembly which will allow a smaller diameter of the rotatable hub assembly due to the increased ease in bending the cable.

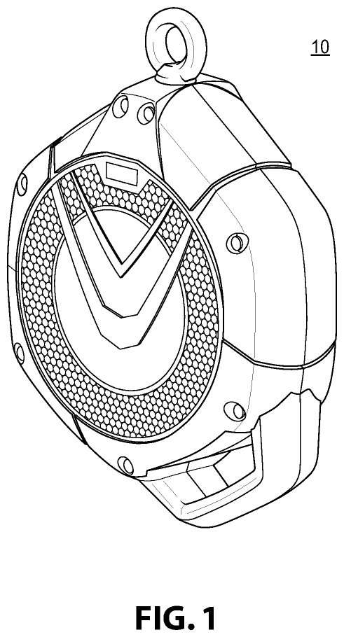

As illustrated in FIG. 1, certain preferred and non-limiting embodiments or aspects of a self-retracting device 10 for use in industrial environments and recreational activities are provided. The self-retracting device 10 can be implemented in any appropriate application or environment where a user or worker engages in activities in an elevated position and requires some protection in the event of a fall. Further, in some non-limiting embodiments or aspects, the self-retracting device 10 of the present disclosure is in the form of a fall protection device or lanyard, such as a self-retracting lanyard. The self-retracting device 10 protects the user should an unintentional, accidental fall commence. The self-retracting device 10 is configured to prevent the user from falling too far or stopping too quickly, as discussed in detail herein.

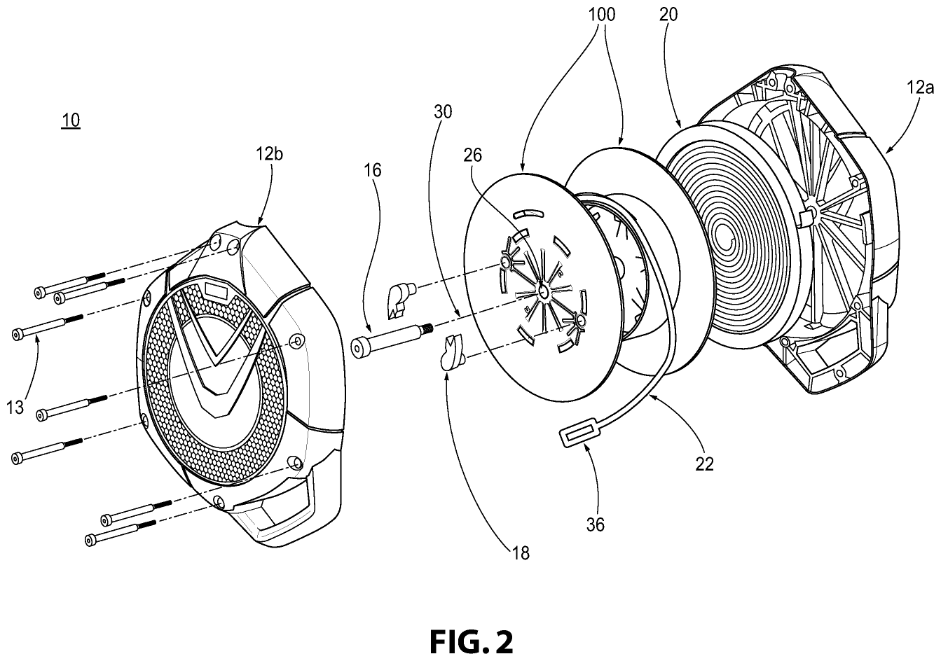

With reference to FIGS. 1-2, and in some non-limiting embodiments or aspects, the self-retracting device 10 includes a rotatable hub assembly 100 having a line 22 (shown in FIG. 2), such as a lifeline, a retraction member 20 biasing the rotatable hub assembly 100 in a first rotational direction of the rotatable hub assembly 100, and an axle 16 about which the rotatable hub assembly 100 and the retraction member 20 rotate. The rotatable hub assembly 100 is configured to (i) retract a line 22 when the rotatable hub assembly 100 moves in the first rotational direction (e.g., a clockwise or counterclockwise direction) and (ii) pay out the line 22 when the rotatable hub assembly 100 moves in the second rotational direction opposite to the first rotational direction.

With continued reference to FIG. 2, and in some non-limiting embodiments or aspects, the self-retracting device 10 includes a housing assembly 12 having a first housing cover 12a and a second housing cover 12b. The first housing cover 12a and the second housing cover 12b may be removably connectable to each other. In some embodiments or aspects, one or more fasteners 13 may be provided for removably connecting the first housing cover 12a to the second housing cover 12b. The one or more fasteners 13 may be disposed about an outer perimeter of the housing assembly 12. The one or more fasteners 13 may be configured to threadably engage a threaded hole in one of the first housing cover 12a and the second housing cover 12b and extend through a hole on the other of the first housing cover 12a and the second housing cover 12b. In some embodiments or aspects, the first housing cover 12a and the second housing cover 12b may be removably connectable to each other by way of clips, adhesive, fasteners, and any combination thereof.

With continued reference to FIG. 2, the housing assembly 12 defines an interior that receives the components of the self-retracting device 10. In some embodiments or aspects, the interior of the housing assembly 12 is configured to receive the rotatable hub assembly 100, the axle 16, a brake assembly 18 (e.g., a braking mechanism), and the retraction member 20. The axle 16 is received by the housing assembly 12 and extends between the first and second housing covers 12a, 12b.

As shown in FIG. 2, the rotatable hub assembly 100 includes a body defining a recessed portion that receives the line 22. The line 22 is wound about the rotatable hub assembly 100 and includes a first end attached to the rotatable hub assembly 100 and a second, free end positioned opposite the first end. An end connector 36 is secured to the second end of the line 22 and is configured to be releasably secured to a user of the self-retracting device 10. The body of the rotatable hub assembly 100 includes an opening 26 that receives the axle 16. The axle 16 may be inserted into the opening 26 that receives the axle 16 through an axis 30 through the center of the opening 26 that receives the axle 16. The rotatable hub assembly 100 is rotatable within the housing assembly 12 and is configured to pay out or retract the line 22 from and to the housing assembly 12.

With reference to FIG. 2, the retraction member 20 is received within the interior of the housing assembly 12 and is configured to bias the rotatable hub assembly 100 in a first rotational direction. The retraction member 20 is positioned between the rotatable hub assembly 100 and the first housing cover 12a. In this manner, the retraction member 20 is configured to (i) retract the line 22 when the rotatable hub assembly 100 moves in the first rotational direction and (ii) pay out the line 22 when the rotatable hub assembly 100 moves in the second rotational direction opposite to the first rotational direction. In some embodiments or aspects, the retraction member 20 may be a power spring having a first end fixed relative to the housing assembly 12 and a second end secured directly or indirectly to the rotatable hub assembly 100. In this manner, rotation of the rotatable hub assembly 100 in the second rotational direction during pay out of the line 22 from the housing assembly 12 builds potential energy in the power spring which is then used to rotate the rotatable hub assembly 100 in the first rotational direction to retract the line 22 into the housing assembly 12. In some non-limiting embodiments or aspects, the retraction member 20 may be a component of the rotatable hub assembly 100.

With reference to FIG. 2, the self-retracting device 10 may have a brake assembly 18 (e.g. a braking mechanism) that is configured to prevent rotation of the rotatable hub assembly 100 upon activation of the brake assembly 18. The brake assembly 18 includes a speed-sensitive mechanism having an activated position and a non-activated position. The speed-sensitive mechanism is rotatable in conjunction with the rotatable hub assembly 100. The speed-sensitive mechanism is configured to transition from the non-activated position to the activated position upon a predetermined rotation speed of the rotatable hub assembly 100. The predetermined rotation speed of the rotatable hub assembly 100 to transition the speed-sensitive mechanism from the non-activated position to the activated position is a known range of rotation speed that is indicative of a fall event. More specifically, the line 22 will pay out from the rotatable hub assembly 100 during a fall event and cause the rotatable hub assembly 100 and speed-sensitive mechanism to rotate at the predetermined rotation speed via their connection to the axle 16. In some non-limiting embodiments or aspects, the speed-sensitive mechanism of the brake assembly 18 may include one or more pawls that are biased to a first position by a biasing member. The biasing force on the one or more pawls is overcome by a centrifugal force when the rotational speed of the rotatable hub assembly 100 exceeds a predetermined threshold, at which the one or more pawls transition to a second position configured for engagement with one or more teeth that slow down and arrest the rotational movement of the rotatable hub assembly 100. Therefore, the brake assembly 18 becomes activated when the rotational velocity of the rotatable hub assembly 100 exceeds the predetermined threshold and prevents rotation of the rotatable hub assembly 100. In some non-limiting embodiments or aspects, the brake assembly 18 may include another mechanism for arresting the rotational movement of the rotatable hub assembly 100 involving one portion of the brake assembly 18 engaging with a second portion (e.g., a member engaging a tab and/or the like).

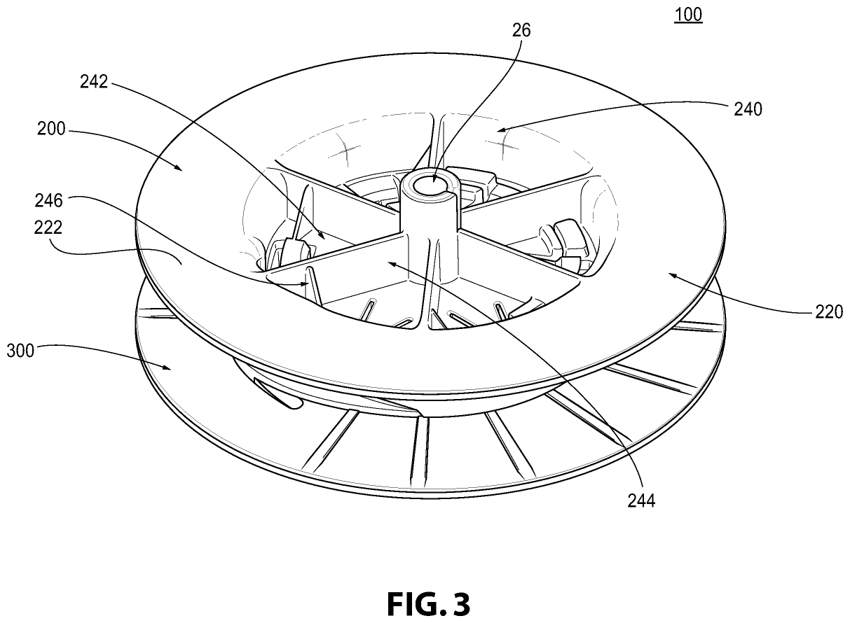

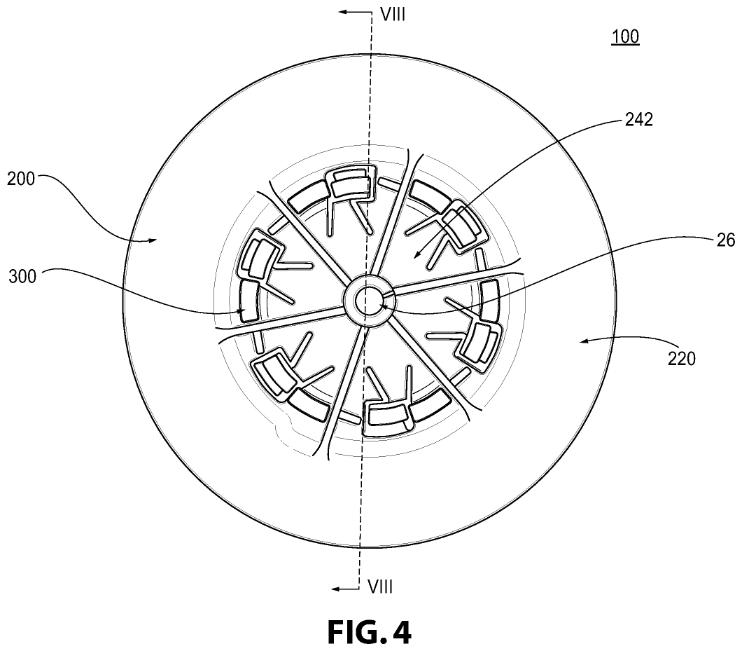

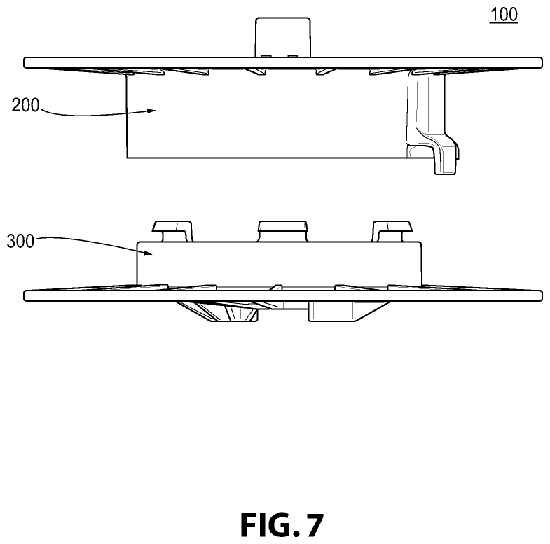

With reference to FIGS. 3-9, and in some non-limiting embodiments or aspects, the rotatable hub assembly 100 includes two portions, a first half 200 and a second half 300. The first half 200 and/or the second half 300 may be made of a plastic material. The use of the plastic material may allow for a cheaper manufacturing of the rotatable hub assembly 100 due to plastic being a cheaper material than metal that is typically used to manufacture rotatable hub assemblies. The first half 200 and second half 300 may be formed using 3D printing, injection molding, compression molding, and/or the like.

The first half 200 is connectable to the second half 300. The first half 200 may be connected to the second half 300 using snap locking tabs. In some non-limiting embodiments or aspects, the first half 200 may be removably connectable to the second half 300 by way of clips, adhesive, tabs, fasteners, threaded connections, and any combination thereof. The first half 200 may include a rim 220. The rim 220 may have a flat outer surface 222 and may be circular in shape. The outer surface 222 may face the first housing cover 12a. The outer surface 222 may be configured to interact with the retraction member 20. The outer surface 222 may include an attachment point to interact with the retraction member 20.

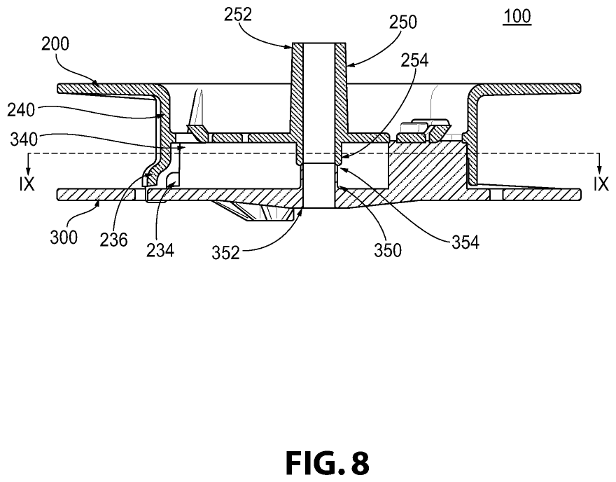

The center of the rim 220 of the first half 200 may include a column 240 that extends along the axis 30. The column 240 may extend opposite of the outer surface 222 of the rim 220 (e.g., towards the second housing cover 12b). The column 240 may include a base surface 242. The base surface 242 may be located at a partial length of the column 240 such that the column 240 continues to extend beyond the base surface 242. The base surface 242 may extend from an inner surface of the column to an outer surface of a sheath 250 that surrounds the opening 26 that receives the axle 16 and extends along the axis 30. The sheath 250 may extend from a sheath beginning 252 to a sheath end 254 (as shown in FIG. 8). The sheath beginning 252 may extend beyond the outer surface 222 of the rim 220. The sheath end 254 may extend beyond the base surface 242 and may stop before the bottom of the column 240.

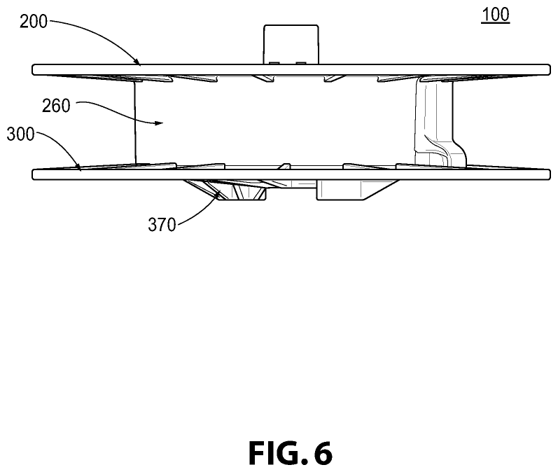

In some non-limiting embodiments or aspects, one or more column plates 244 may extend from the outer surface of the sheath 250 to the inner surface of the column 240. The column plates 244 may provide structural support for the first half 200. The column plates 244 may be located equidistance around the sheath 250 and may extend out in the radial direction. One or more column plate supports 246 may be attached to the column plate 244 and the base surface 242 to provide additional structural support. The column plates 244 may extend from the base surface 242 to the outer surface 222 of the rim 220. The outer surface of the column 240 may form a drum 260 (as shown in FIG. 6). The drum 260 may be configured to allow a line 22 to be wrapped around the drum 260.

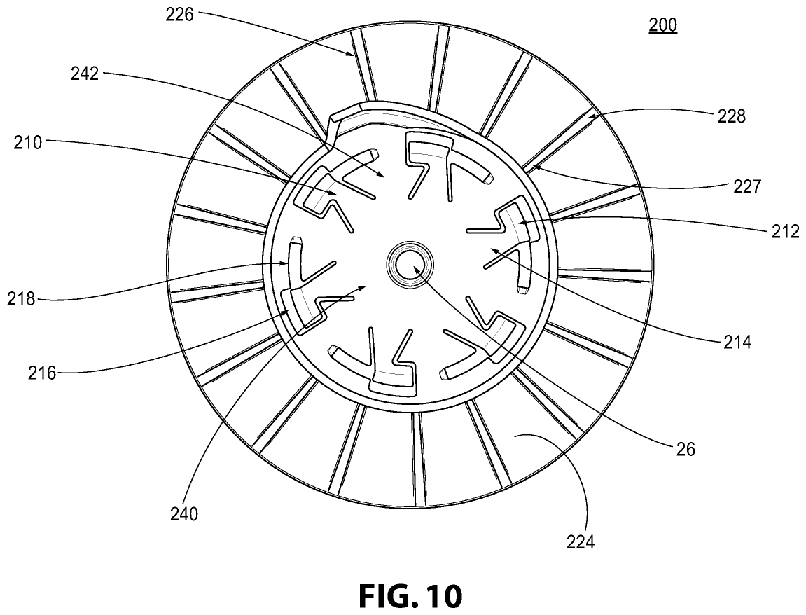

The inner surface 224 of the rim 220 may include one or more ribs 226 (as shown in FIG. 10). The ribs 226 may extend radially from the outer surface of the column 240 to the edge of the rim 220. The ribs 226 may have a varying height along the length of the rib 226 such that the rib 226 has the tallest height at the column end 227 of the rib 226 and has the shortest height at the edge of the rim end 228.

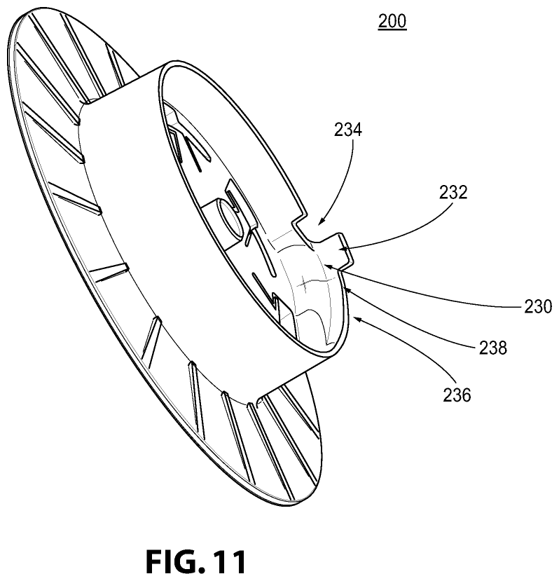

In reference to FIGS. 10 and 11, the first half 200 may include one or more connectors for connecting the first half 200 to the second half 300. In some non-limiting embodiments or aspects, the connector may include a retractable tab 210 that may include a tab head 212. The tab head 212 may be located in an opening 216 for the tab head 212 in the first half 200. The tab head 212 may be connected to a tab body 214 on one end of the tab head 212. The tab body 214 may extend from the tab head 212 to the base surface 242. The one or more retractable tabs 210 may be located radially around the opening 26 that receives the axle 16 (e.g., a slot for the axle). For example, the first half 200 may include 2, 3, 4, 5, 6, 7, or 8 retractable tabs 210 arranged in a circle around the opening 26 that receives the axle 16 such that each retractable tab 210 is located equidistant from the next retractable tab 210. The retractable tab 210 may be located in a tab opening 216 in the base surface 242. The retractable tab 210 may be biased to a closed position. The retractable tab 210 may be movable into an open position. The retractable tab 210 may be moved to the open position by a force applied to the tab head 212 that bends the tab body 214. Once the force to the tab head 212 is removed, the tab body 214 may return to its original position (e.g. the closed position). The tab body 214 may be biased towards the closed position (e.g., by a tension in the tab body 214, a spring, magnet, and/or the like).

In some non-limiting embodiments or aspects, the first half 200 may include a second tab opening 218. The second tab opening 218 may be configured to allow the insertion of a second tab. The second tab may be associated with the second half 300. The second tab may be inserted by moving the retractable tab 210 into the open position by inserting the second tab into the opening 216 such that the second tab applies a force to the tab head 212 and then rotating the inserted tab into the second tab opening 218. The retractable tab 210 may move to the closed position after the inserted tab is rotated into the second tab opening 218.

In some non-limiting embodiments or aspects, the first half 200 may include a line slot 230. The line slot 230 may be configured to allow a line 22 to extend from the inside of the column 240 to the outside of the column 240. The line slot 230 may include a line slot wall 236 that is connected to the column 240 and extends beyond the drum 260. The line slot wall 236 may be semicircular in shape and may form a line slot chamber 238 and a line slot opening 234. The line slot chamber 238 may widen in size from the beginning of the line slot chamber 238 to the end of the line slot chamber 238. The beginning of the line slot chamber 238 may be flush with the drum 260. The line slot opening 234 may be large enough to fit the line 22.

In some non-limiting embodiments or aspects, the line slot 230 may include a line tab 232 at an end of the line slot 230. The line tab 232 may form a portion of the line slot wall 236 and may be located at the end of the line slot wall 236. The line tab 232 may extend beyond the column 240 along the axis 30. The line tab 232 may be configured to bend the line 22 when the line tab 232 is moved in a rotational direction and comes in contact with the line 22. The line tab 232 may bend the line 22 such that the portion of the line 22 that extends outside of the drum 260 is tangential to the drum 260, allowing the line 22 to wrap around the outer perimeter of the drum 260.

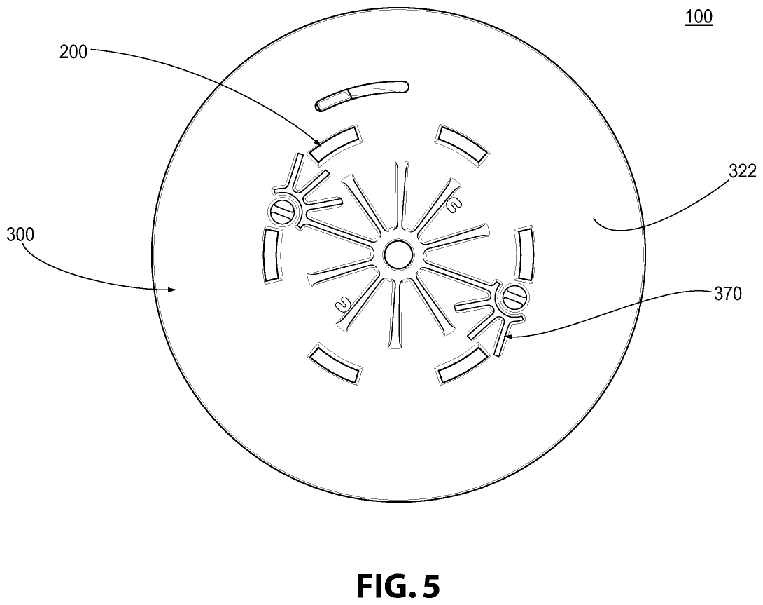

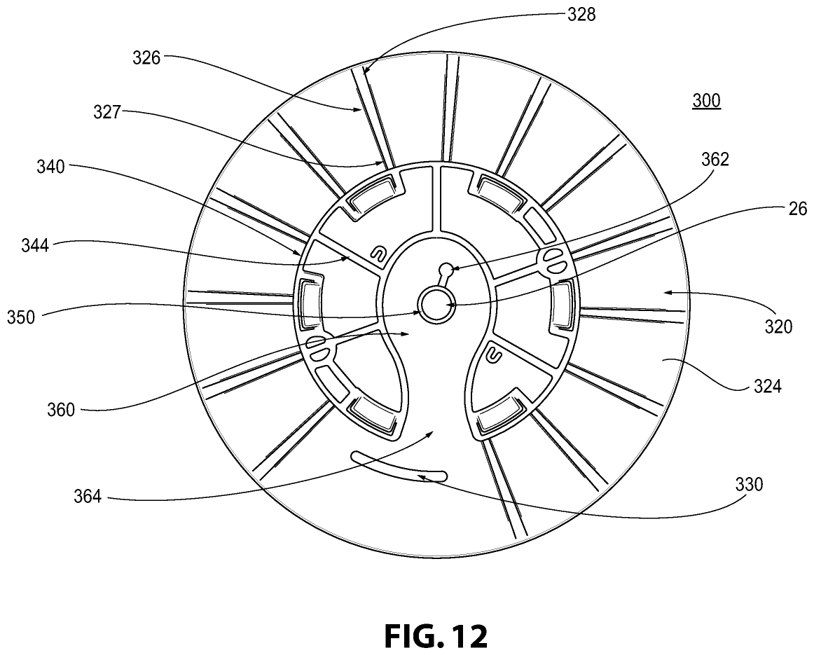

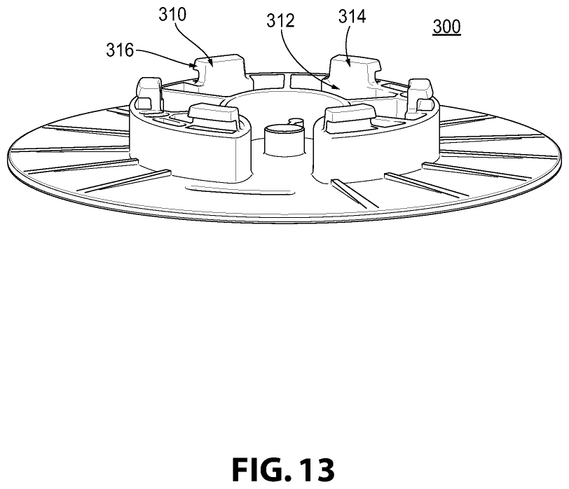

In reference to FIGS. 5 and 12-13, the second half 300 may include a rim 320. The rim 320 may have a flat outer surface 322 and may be circular in shape. The outer diameter of the rim 320 may be the same outer diameter of the rim 220 of the first half 200. The outer surface 322 of the rim 320 may face the second housing cover 12b. The outer surface 322 may be configured to interact with the brake assembly 18. The outer surface 322 may be configured to engage with the brake assembly 18 when the brake assembly 18 is in the activated position. When in the activated position, the brake assembly 18 may slow down and arrest the rotational movement of the rotatable hub assembly 100. In some non-limiting embodiments or aspects, the outer surface 322 may include one or more ribs 370. The one or more ribs 370 may provide structural support to the second half 300. The ribs 370 may support the forces that are transferred to the second half 300 from the braking assembly 18.

In some non-limiting embodiments or aspects, the center of the rim 320 of the second half 300 may include a column 340 that extends along the axis 30. The column 340 may extend opposite of the outer surface 322 of the rim 320 (e.g., towards the first housing cover 12a). The bottom of the column 340 may be flush with the rim 320. The column 340 of the second half 300 may be configured to interact with the column 240 of the first half 200. The height of the column 340 of the second half 300 may be configured such that it is shorter than the distance from the base surface 242 and the end of the column 240 of the first half 200. The outer diameter of the column 340 of the second half 300 may be smaller than the inner diameter of the column 240 of the first half 200. Therefore, the column 340 of the second half 300 may be configured such that when the first half 200 is connected to the second half 300, the column 340 of the second half 300 may fit inside of the column 240 of the first half 200.

In some non-limiting embodiments or aspects, the center of the rim 320 of the second half 300 may also include a sheath 350 that surrounds the opening 26 that receives the axle 16 and extends along the axis 30. The sheath 350 may extend from a sheath beginning 352 to a sheath end 354 (as shown in FIG. 8). The sheath beginning 352 may extend to the outer surface 322 of the rim 320. The sheath end 354 may extend along the axis 30 towards the first housing cover 12a and may end before the end of the column 340.

In some non-limiting embodiments or aspects, the second half sheath 350 may be configured to interact with the first half sheath 250 such that the opening 26 that receives the axle 16 is enclosed by either the second half sheath 350 or the first half sheath 250 along the axis 30 enclosed by the rotatable hub assembly 100. In some non-limiting embodiments or aspects, the inner diameter of the first half sheath 250 may be wider than the outer diameter of the second half sheath 350 such that the second half sheath 350 may be inserted into the first half sheath 250. In some non-limiting embodiments or aspects, the first half sheath 250 may be flush with the second half sheath 350 when the first half 200 is connected to the second half 300 such that the first half sheath 250 and the second half sheath 350 have the same inner diameter. When the first half 200 is connected to the second half 300, the axle 16 may be inserted such that the body of the axle 16 extends through the entire length of both the first half sheath 250 and the second half sheath 350.

In some non-limiting embodiments or aspects, an interior 360 may be defined between the column 340 and the sheath 350. The column 340 may include an opening 364 such that the column 340 forms a U-shape. The opening 364 may connect the interior 360 to the outside of the column 340. The column 340 may be hollow. The column 340 may include one or more column plates 344. The column plates 344 may extend from one portion of the column wall to another portion of the column wall. The column plates 344 may extend in the radial direction. The column plates 344 may extend from the inner surface 324 of the rim 320 to the top of the column 340. The column 340 may not have a top surface, leaving the inside of the column 340 open.

In some non-limiting embodiments or aspects, the inner surface 324 of the rim 320 may include one or more ribs 326. The ribs 326 may extend radially from the outer surface of the column 340 to the edge of the rim 320. The ribs 326 may have a varying height along the length of the rib 326 such that the rib 326 has the tallest height at the column end 327 of the rib 326 and has the shortest height at the edge of the rim end 328.

In some non-limiting embodiments or aspects, the rim 320 may include a tab opening 330. The tab opening 330 may be configured to receive the line tab 232 when the first half 200 is connected to the second half 300. The tab opening 330 may allow the line tab 232 to slide from an open position to a closed position. The open position may correlate to when the first half 200 and second half 300 are not connected. In the open position, the line tab 232 may be located at least partially in front of the opening 364. The closed position may correlate to when the first half 200 and the second half 300 are connected. In the closed position, the line tab 232 may be located in front of the wall of the second half column 340.

In some non-limiting embodiments or aspects, the second half may include one or more tabs 310 located on the top of the column 340. The second half tabs 310 may include a tab base 312, a tab back 314, and a tab lip 316. The tab base 312 may be located inside of the column 340. The tab base 312 may be connected to the wall of the column 340 and may be connected to the second half rim 320. The tab base 312 may form a box with four walls. One wall may be the wall of the column 340. Two walls may extend from the inside surface of the wall of the column 340 into the hollow center of the column 340. The length of these two walls may be such that they are as long as or longer than the tab lip 316 of the second half tabs 310. The fourth wall may be a back wall that connects the ends of these two walls. The walls of the tab base 312 may extend from the second half rim 320 to the top of the column 340. The back wall may be as wide as the tab lip 316.

In some non-limiting embodiments or aspects, the tab back 314 may extend up from the back wall of the tab base 312. The tab back 314 may be as wide as the back wall and extends beyond the height of the column 340. A tab lip 316 may be located at the top of the tab back 314. The tab lip 316 may extend radially outward from the tab back 314.

In some non-limiting embodiments or aspects, the tab back 314 may be tall enough such that when the first half 200 is connected to the second half 300, the tab lip 316 is above the base surface 242. The tab back 314 may be short enough such that the bottom of the tab lip 316 is in contact with the base surface 242. The tab back 314 may be thin enough such that it can fit within the second tab opening 218. The tab lip 316 may be long enough that it extends beyond the second tab opening 218 but short enough that it does not extend into the wall of the first half column 240.

In some non-limiting embodiments or aspects, the interior 360 may be configured to contain a line 22 such that the line 22 can loop around the sheath 350 and exit through the opening 364. The interior 360 may include a line guide 362 to control the location of the line 22 within the interior 360. The line guide 362 may be at least one post configured to create a separation between the line 22 and the sheath 350. The line guide 362 may be a groove in the rim 320.

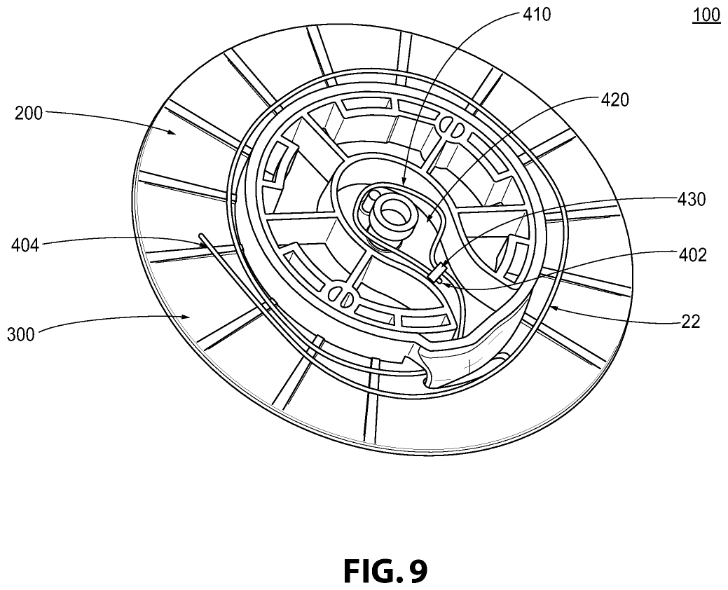

In reference to FIG. 9, the line 22 may include a front end 402 and a back end 404. The line may be bent such that the front end 402 forms a loop 410 (e.g., eyelet) in the line 22. The line 22 may be bent such that the front end 402 is parallel with another portion of the line 22. The front end 402 may be secured to the line 22 to form the loop 410. The front end 402 may be secured with a connector 430, such as a ferrule termination, weld, adhesive, and/or the like.

In some non-limiting embodiments or aspects, the loop 410 may be placed in between the first half 200 and the second half 300 in the interior 360. The loop 410 may be placed such that the second half sheath 350 goes through the opening 420 formed by the loop 410. A smaller second half sheath 350 outer diameter may allow for a tighter loop 410.

In some non-limiting embodiments or aspects, the first half 200 may be connected to the second half 300 by a rotational motion. The first half 200 may be aligned with the second half 300 such that the second half tabs 310 are aligned with the tab heads 212 of the retractable tabs 210 in the first half 200. The first half 200 and the second half 300 may then be pressed together. The tab lip 316 (e.g. the upper portion) of the second half tab 310 will apply a force to the tab head 212 in the first half 200, causing the retractable tab 210 to move into an open position. The tab lip 316 may be completely above the base surface 242 (e.g., if the first half 200 or the second half 300 were rotated, the tab lip 316 would not impact the base surface 242).

In some non-limiting embodiments or aspects, the first half 200 or the second half 300 may be rotated (e.g., moved in the clockwise or counterclockwise direction). The second half tabs 310 and the retractable tabs 210 may form snap locking tabs when engaged with each other. The rotational motion may move the second half tabs 310 from the opening 216 for the tab head 212 to the second tab opening 218. Once the second half tab 310 is moved out from under the tab head 212, the retractable tab 210 may move to the closed position. In the closed position, the retractable tab 210 may prevent the second half tab 310 from moving out of the second tab opening 218. A surface of tab lip 316 (e.g., the bottom surface) may come in contact with a surface of the base surface 242. This will prevent the first half 200 and the second half 300 from rotating backwards, disassembling, or disconnecting from each other.

In some non-limiting embodiments or aspects, the rotation of the first half 200 or the second half 300 may cause the line tab 232 to come in contact with a portion of the line 22. The use of a loop 410 and connector will result in the line to want to extend radially from the axle 16. The continued rotational motion after initial contact will cause the line tab 232 to apply a force to the line 22, causing the line 22 to bend (e.g. a segment of the line 22 may become tangential with the drum 260). The use of the line tab 232 to bend the line 22 can result in a decreased diameter of the drum 260 due to a decrease in the amount of effort required to bend the line 22. The remainder of the line 22 may be wrapped around the drum 260 (e.g., the perimeter of the rotatable hub assembly 100). The bend of the line 22 may occur such that the bend and the loop 410 are in the same plane. By keeping the bend in the same plane as the loop 410, the bend radius of the line 22 can be decreased, resulting in a smaller rotatable hub assembly 100 design. By initiating the bend using the line tab 232 through a rotational movement, it is possible to start a smooth tangential wrap of the cable around the drum 260.

In some non-limiting embodiments or aspects, the rotatable hub assembly 100 may be assembled by placing the loop 410 of the line 22 in the interior 360 around the sheath 350 of the second half 300 such that the sheath 350 is inserted through an opening 420 defined by the loop 410. The line 22 may extend out of the interior 360 of the second half 300. The first half 200 may be placed on the second half 300 such that the sheath 350 of the second half 300 aligns with the sheath 250 of the first half 250 and the outer surface 322 of the rim 320 of the second half 300 faces away from the outer surface 222 of the rim 220 of the first half 200. The second half tabs 310 may also be aligned with the tab heads 212 of the retractable tabs 210 in the first half 200. The first half 200 may then be connected to the second half 300. An axle 16 may then be inserted through the sheath 250 of the first half 200, the sheath 350 of the second half 300, and the opening 420 defined by the loop 410. The body of the line 22 may then be extended around the perimeter of the rotatable hub assembly 100.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A self-retracting device comprising:
a rotatable hub assembly comprising a first half and a second half, wherein:
the first half comprises a retraction member and a first slot for an axle;
the second half comprises a second slot for the axle;
the first half is connectable to the second half; and
the retraction member biases the rotatable hub assembly in a first rotational direction;
the axle comprising a body extending through the first slot of the first half and the second slot of the second half; and
a line wherein:
a first end of the line comprises a loop positioned between the first half and the second half of the rotatable hub assembly and extending around the body of the axle; and
a second end of the line opposite the first end configured for extending around a perimeter of the rotatable hub assembly, wherein the rotatable hub assembly is configured to:
retract the line when the rotatable hub assembly moves in the first rotational direction; and
pay out the line when the rotatable hub assembly moves in a second rotational direction opposite the first rotational direction.

2. The self-retracting device of claim 1, wherein the loop is formed with a ferrule termination.

3. The self-retracting device of claim 1, wherein the first half and the second half are made of a plastic material.

4. The self-retracting device of claim 1, wherein the first half is connected to the second half with one or more snap locking tabs.

5. The self-retracting device of claim 4, wherein the one or more snap locking tabs prevents the first half and the second half from rotating backwards and disassembling.

6. The self-retracting device of claim 1, wherein the first half is connected to the second half through a rotational motion, wherein the first half or the second half comprises a line tab for bending the line around the perimeter during the rotational motion.

7. The self-retracting device of claim 6, wherein the line tab causes the line to bend tangentially with the perimeter of the rotatable hub assembly.

8. The self-retracting device of claim 1, wherein the line bends around the perimeter in a same plane as the loop.

9. The self-retracting device according to claim 1, wherein the second half comprises a braking mechanism configured to prevent rotation of the rotatable hub assembly upon activation of the braking mechanism when a rotational velocity of the rotatable hub assembly exceeds a predetermined threshold.

10. The self-retracting device according to claim 9, wherein the braking mechanism comprises a first portion and a second portion, and wherein the first portion engages with the second portion when the predetermined threshold is exceeded.

11. A method of assembling a self-retracting device comprising:
placing a loop of a first end of a line on a first half of a rotatable hub assembly;
placing a second half of the rotatable hub assembly on the first half of the rotatable assembly such that the loop is between the first half and the second half;
inserting an axle through an assembly slot extending through the first half and the second half of the rotatable hub assembly such that the loop of the line extends around a body of the axle; and
wrapping a body of the line around a perimeter of the rotatable hub assembly.

12. The method of assembling the self-retracting device of claim 11, wherein the loop is formed with a ferrule termination.

13. The method of assembling the self-retracting device of claim 11, wherein the first half and the second half are made of a plastic material.

14. The method of assembling the self-retracting device of claim 11, further comprising connecting the second half of the rotatable hub assembly to the first half of the rotatable hub assembly with one or more snap locking tabs.

15. The method of assembling the self-retracting device of claim 14, wherein the one or more snap locking tabs prevents the first half and the second half from rotating backwards and disassembling.

16. The method of assembling the self-retracting device of claim 11, further comprising connecting the second half of the rotatable hub assembly to the first half of the rotatable hub assembly by placing the second half on the first half and rotating the second half, wherein the first half or the second half comprises a line tab, wherein the line tab bends the body of the line around the perimeter during the rotation of the second half.

17. The method of assembling the self-retracting device of claim 16, wherein the line tab bends the body of the line tangentially with the perimeter of the rotatable hub assembly.

18. The method of assembling the self-retracting device of claim 11, wherein the line bends around the perimeter in the same plane as the loop.

19. The method of assembling the self-retracting device according to claim 11, wherein the second half comprises a braking mechanism configured to prevent rotation of the rotatable hub assembly upon activation of the braking mechanism when a rotational velocity of the rotatable hub assembly exceeds a predetermined threshold.

20. The method of assembling the self-retracting device according to claim 19, wherein the braking mechanism comprises a first portion and a second portion, wherein the first portion engages with the second portion when the predetermined threshold is exceeded.
